(19) United States
(12) Patent Application Publication
(10) Pub. No.: US 2012/0082795 A1
(43) Pub. Date: Apr. 5, 2012

(54) METHOD FOR USING A PRIMER COMPRISING A SELF-EMULSIFIED POLYESTER MICROGEL

(75) Inventors: Christopher A. Verardi, Pittsburgh, PA (US); Michele L. Meli, Ambridge, PA (US); Paul Lamers, Allison Park, PA (US)

(73) Assignee: PPG Industries Ohio, Inc., Cleveland, OH (US)

(21) Appl. No.: 12/896,166

(22) Filed: Oct. 1, 2010

(51) Int. Cl. B05D 1/36; B05C 9/12

(52) U.S. Cl. 427/385.5; 118/58

(57) ABSTRACT

A method for coating a substrate comprising applying to at least a portion of the substrate a primer coating composition comprising a self-emulsified polyester microgel is disclosed. Multilayer coating systems comprising such a primer are also disclosed.

### FIELD OF THE INVENTION

The present invention relates to methods for coating substrates, and, particularly, to composite coatings including a primer layer, basecoat, and optionally a clearcoat, which are applied in a wet-on-wet-on-wet process. The primer layer comprises a self-emulsified polyester microgel.

### BACKGROUND OF THE INVENTION

In the automotive industry, a coating system that provides a good balance between economy, appearance, and physical properties is a system having four individual coating layers. The first coating is a corrosion resistant layer, which is typically applied by electrodeposition and cured. The next coating is a primer/surfacer, which is spray applied and then cured. The third coating is a spray-applied colored basecoat. The basecoat is generally not cured before the application of the final coating, the clear coat, which is designed to provide toughness and high gloss to the system. The process of applying one layer of a coating before the previous layer is cured is referred to as a wet-on-wet (“WOW”) application.

The automotive industry would derive a significant economic advantage from an inexpensive coating process that provides a coated substrate having good adhesion, chip resistance, and/or smoothness, yet that can be applied wet-on-wet, or even wet-on-wet-on-wet (“WOWOW”).

### SUMMARY OF THE INVENTION

The present invention provides a method for coating a substrate, comprising: a) applying a primer coating composition onto at least a portion of a substrate, wherein the primer coating composition comprises a self-emulsified polyester microgel; b) applying a second coating composition to at least a portion of the substrate coated with the primer coating composition of component (a) without first substantially curing the primer coating composition of component (a); c) optionally, applying a third coating composition to at least a portion of the substrate coated with the coating composition of component (b) without first substantially curing (a) and/or (b); and d) substantially curing the coating compositions of components (a), (b) and, if used, (c).

The present invention also provides a multilayer coating system comprising: a) a primer coating composition applied to at least a portion of a substrate, wherein the primer coating composition comprises a self-emulsified polyester microgel; b) a second coating composition applied to at least a portion of the substrate coated with the primer coating composition of component (a) without first substantially curing the primer coating composition of component (a); c) optionally, a third coating composition applied to at least a portion of the substrate coated with the coating composition of component (b) without first substantially curing (a) and/or (b); d. substantially curing the coating compositions of components (a), (b) and, if used, (c).

### DETAILED DESCRIPTION OF THE INVENTION

The present invention provides methods for coating a substrate using wet-on-wet or wet-on-wet-on-wet procedures. More specifically, the methods comprise a first step of applying a primer coating composition to at least a portion of the surface of a substrate and then, without substantially curing the primer, applying a second coating composition. Optionally, a third coating composition is applied in a “wet-on-wet-on-wet” type of application process to the substrate coated with the primer and second coat. The applied coating compositions are all cured simultaneously to provide a multilayer coating system.

In certain methods of the present invention, a primer coating is applied to at least a portion of the substrate. In certain embodiments, the primer coating is aqueous. The substrate can be pretreated and/or electrocoated, as discussed below, using methods standard in the art prior to application of the primer. The primer coating composition comprises a self-emulsified polyester microgel. As used herein, the term “self-emulsified” means that the microgel has sufficient ionic and/or hydrophilic character to allow it to form a stable dispersion in water without the use of added stabilizers such as surfactants. In a stable dispersion, the dispersed phase will remain dispersed, i.e., the particles will not coagulate or settle, for an extended period of time, such as at least six months at ambient temperature. As used herein, the term “microgel” refers to an aqueous dispersion of internally crosslinked polymer microparticles. In some embodiments, the self-emulsified polyester microgel is insoluble in organic solvents such as tetrahydrofuran, while in other embodiments it may be at least partially soluble in such solvents.

In certain embodiments of the present invention, the self-emulsified polyester microgel comprises a self-emulsified polyester-melamine microgel. The self-emulsified polyester-melamine microgel comprises a polyester, which has two or more hydroxyl groups and a plurality of carboxylic acid groups.

The polyester of the self-emulsified polyester-melamine microgel can be prepared from polyols and polycarboxylic acids and/or anhydrides using methods known to those skilled in the art. A polyol will be understood by those skilled in the art as a compound having two or more hydroxyl groups. Suitable polyols can include ethylene glycol; 1,2- and 1,3-propanediol; 2-methyl-1,3-propanediol; 1,3- and 1,4-butanediol; 1,6-hexanediol; 1,4-cyclohexane dimethanol; neopentyl glycol; trimethylolpropane; glycerin; and pentaerythritol. Any suitable mono- or polycarboxylic acid/anhydride can be used according to the present invention. It will be understood by those skilled in the art that a polycarboxylic acid is one that has two or more acid functional groups, or residues thereof, such as anhydride groups. Suitable monocarboxylic acids include benzoic acid, nonanoic acid, and fatty acids such as those that are derived from natural sources, for example coconut oil fatty acid, tall oil fatty acid, isomerginic acid, soya oil fatty acid, and castor oil fatty acid. Suitable polycarboxylic acids/anhydrides include phthalic acid/anhydride, adipic acid/anhydride, cyclohexanedicarboxylic acid, isophthalic acid, terephthalic acid, trimellitic anhydride, the C36 dimer fatty acids, maleic acid/anhydride, and fumaric acid/anhydride.

As discussed above, the polyester contains a plurality of carboxylic acid groups. It will be understood by those skilled in the art that a sufficient number of carboxylic acid groups should be present within the polyester structure to allow the polyester-melamine microgel formed from the polyester to be stable as a dispersion in water when neutralized at least partially by a base. The desired number of carboxylic acid groups, and the desired amount of neutralization of those acid groups, can be determined by standard methods known by practitioners in the field. In certain embodiments, a suitable acid value for the polyester can be 22 to 42, such as 28 to 36, where the number refers to the number of milligrams of potassium hydroxide required to neutralize one gram of polyester, as determined by titration. In certain embodiments, the polyester also contains another reactive functional group or groups, such as hydroxyl groups, to allow the polyester-melamine microgel to react with crosslinkers that may be added to the primer coating composition when it is formulated.

The polyester of the polyester-melamine microgel can be optionally dissolved in an organic solvent prior to formation of the microgel. Suitable organic solvents include acetone, butanone and 4-methyl-2-pentanone. In some embodiments, the solvent is a volatile solvent or mixture of solvents that can be distilled from the microgel after it has been formed.

The melamine of the polyester-melamine microgel can be any type of aminoplast crosslinking resin, such as the melamine resins that are available commercially under the CYMEL trade name from Cytec Industries Inc. Suitable versions of melamine crosslinkers can be, for example, those that are classified as methylated, high-imino melamine derivatives such as those that are sold under the trade name of CYMEL 327.

The polyester-melamine microgel can be formed from the above polyester and melamine resin using methods standard in the art. In certain embodiments, the melamine is dissolved in the polyester and the optional organic solvent and mixed until it is incorporated. The ratio of the polyester to the melamine can vary from 50:50 to 90:10, such as from 60:40 to 80:20. The mixture is inverted into the aqueous phase by neutralizing at least a portion of the acid groups of the polyester and adding water. The neutralizing agent can be a water soluble base such as an amine. Suitable amines are well-known to those skilled in the art and include triethylamine, dimethylethanolamine, N,N-dimethyldodecylamine, diisopropylamine, triethanolamine, and diethylethanolamine. The degree of neutralization can be from 40% to 100%, such as from 60% to 100%. The neutralizing amine may be added either before or during the addition of the water, and it may be added in portions. The amine and water (combined or sequentially) may be added to the solution of the polyester and melamine resins, or the resin solution may be added to the amine and water. In the latter case, the amine may be added to the resin solution before it is added to the water, or the resin solution may be added to a solution of the amine in water. In certain embodiments, the microgel is formed without the use of a MICROFLUIDIZER high pressure impingement emulsifier (available from Microfluidics Corporation in Newton, Mass.) or any other high-stress technique.

The aqueous dispersion thus obtained is held at elevated temperatures to allow the crosslinking reaction between the melamine resin and the polyester resin to take place. A suitable reaction temperature is typically 50° C. to 100° C., such as 70° C. to 100° C. The progress of the reaction may be monitored by viscosity measurements and/or by turbidity measurements. An increase in viscosity and/or turbidity indicates an increase in the molecular weight of the polymer mixture, which is the result of the internal crosslinking reaction and formation of the microgel particles. A reaction endpoint may be indicated when there is no further change in the viscosity and/or turbidity measurement of the reaction mixture samples with time. The optional organic solvent(s) may be distilled from the reaction mixture, using a vacuum if necessary, after the microgel is formed. Upon completion of the reaction, the polymer may be further neutralized with additional amine, such as up to 100% if the prior degree of neutralization was less than 100%.

In another embodiment of the present invention, the self-emulsified polyester microgel of the primer coating composition comprises a self-emulsified polyester-acrylic microgel. The self-emulsified polyester-acrylic microgel comprises a polyester that comprises a plurality of carboxylic acid groups. As with the polyester described above, it is typically desired to have sufficient carboxylic acid groups so as to allow the polymer to form a stable dispersion in water when at least some of the carboxylic acid groups are neutralized. In addition to carboxylic acid groups, the polyester comprises a polymerizable double bond and may also comprise hydroxyl and/or other functional groups.

The polyester of the self-emulsified polyester-acrylic microgel can be prepared from a polyol and a polycarboxylic acid and/or anhydride, using methods known to those skilled in the art. At least some of the polycarboxylic acid and/or anhydride will comprise a polymerizable double bond. Suitable polyols include those listed above for the self-emulsified polyester-melamine microgel. Additionally, the polyol can be an epoxy resin such as a Bisphenol A—epichlorohydrin resin, an ethoxylated epoxy resin such as an ethoxylated Bisphenol A polyol, and/or a polyether polyol such as poly(tetrahydrofuran) diol. Suitable polycarboxylic acids and/or anhydrides include those listed above for the self-emulsified polyester-melamine microgel. Suitable polycarboxylic acids/anhydrides comprising a polymerizable double bond include maleic acid/anhydride, fumaric acid, trimethyolol propane monoallyl ether, and itaconic acid. In one embodiment, the polyester can be prepared from epoxy resin, ethoxylated epoxy resin, 1,4-cyclohexanedimethanol, isononanoic acid, trimellitic anhydride and maleic anhydride.

The acrylic of the self-emulsified polyester-acrylic microgel comprises ethylenically unsaturated monomers known to those skilled in the art. Such monomers include vinyl monomers such as styrene, alpha-methylstyrene, and isobutylene; acrylic acid and its esters, including methyl, ethyl, n-butyl, 2-hydroxyethyl, and 2-hydroxypropyl ester; methacrylic acid and it esters, including methyl, ethyl, n-butyl, 2-hydroxyethyl, and 2-hydroxypropyl ester; and mixtures thereof. In certain embodiments, the ethylenically unsaturated monomers comprise a functional monomer, such as a hydroxyl functional monomer, to allow the polyester-acrylic microgel to react with crosslinkers that may be added to the primer coating composition when it is formulated.

The self-emulsified polyester-acrylic microgel can be formed from the above polyester and acrylic monomers by any means known in the art. In one embodiment, the polyester is inverted into the aqueous phase by neutralizing at least a portion of the acid groups of the polyester and adding water. The neutralizing agent can be a water soluble base such as an amine. Suitable amines are well-known to those skilled in the art and may include those listed above for the polyester-melamine microgel. The degree of neutralization can be from 40% to 100%, such as from 60% to 100%. The neutralizing amine may be added either before or during the addition of the water, and it may be added in portions. The amine and water (combined or sequentially) may be added to the solution of the polyester and melamine resins, or the resin solution may be added to the amine and water. In the latter case, the amine may be added to the resin solution before it is added to the water, or the resin solution may be added to a solution of the amine in water.

The polyester may be optionally dissolved in an organic solvent prior to neutralization and dispersion. Suitable organic solvents include alcoholic solvents such as ethanol, isopropanol, n-butanol, the propylene and/or ethylene glycol alkyl ethers, the diethylene and/or dipropylene glycol alkyl ethers; ketone solvents such as acetone, butanone, and 4-methyl-2-pentanone; ester solvents such as butyl acetate or ethyl lactate; and mixtures thereof. In some embodiments, the solvent is a volatile solvent or mixture of solvents that can be distilled from the microgel after it has been formed.

To the aqueous polyester thus obtained, the ethylenically unsaturated monomers are added to form an emulsion. The ratio of polyester to acrylic can be from 10:90 to 90:10, such as from 30:70 to 70:30. Polymerization of the ethylenically unsaturated monomers can be accomplished by standard methods knows to those skilled in the art. For example, polymerization can be initiated by ammonium persulfate, or by a redox system such as isoascorbic acid/hydrogen peroxide/ferrous ammonium sulfate. It will be appreciated by those skilled in the art that, in addition to the polymerization of the ethylenically unsaturated monomers with other ethylenically unsaturated monomers, the polymerizable double bond of the polyester will react with some of the ethylenically unsaturated monomers under these conditions, causing the formation of an internally crosslinked polyester-acrylic copolymer. The length of time required to complete polymerization can vary, for example, from 10 minutes to 6 hours. The temperature of reaction can range from, for example, 25° C. to 80° C., such as from 35° C. to 45° C. The progress of the polymerization reaction can be monitored by techniques conventionally known to those skilled in the art of polymer chemistry. For example, heat generation, monomer concentration and percent of total solids are all methods of monitoring the progress of the polymerization. The optional organic solvent(s) may be distilled from the reaction mixture, using a vacuum if necessary, after the microgel is formed. Upon completion of the reaction, the polymer may be further neutralized with additional amine, such as up to 100% if the prior degree of neutralization was less than 100%.

In some embodiments, the self-emulsified polyester-acrylic microgel can itself be the film former, it can be used in combination with other film formers, and/or it can comprise part or all of the pigment grind vehicle in the coating composition. Use of the polyester acrylic microgel as all or part of the grind vehicle may provide better sag control in the primer coating composition, and/or it may allow for a higher solids content, such as 55% or higher, in the primer coating composition.

While the inventors do not wish to be bound by any particular theory, it may be that the presence of the self-emulsified polyester microgel in the primer coating composition improves the “hold-out” of the subsequently applied coating composition (b). As used herein, the term hold-out refers to preventing or minimizing significant mixing between a first applied uncured coating composition and the subsequently applied uncured coating composition(s), i.e., the layers remain largely separate and distinct. Thus, the present invention allows for maintenance of separate and distinct layers in a wet-on-wet, or wet-on-wet-on-wet, application. A coating system that does not have good hold-out between the layers may have poor appearance, such as “mud-cracking”, which is evidenced by small cracks or fissures on the surface of the coating, or by consistency of shortwave appearance over a range of processing conditions.

The self-emulsified polyester microgel can be used in the primer coating composition in any amount desired by the user. In certain embodiments, it can range from 20% to 80% by weight on a basis of total resin solids of the primer coating composition, such as from 40% to 60%.

The primer coating composition comprising the self-emulsified polyester microgel may further comprise an additional aqueous polymeric resin such as a polyurethane resin, a polyester-polyurethane resin, a thermosettable dispersion, or combinations thereof. For example, the additional aqueous polymeric resin can be a polyurethane dispersion such as that described in Example 1 of U.S. Pat. No. 7,709,093, incorporated in pertinent part by reference herein. An example of a thermosettable dispersion is described in U.S. Pat. No. 6,180,181 (column 3, line 26 through column 13, line 8), incorporated in pertinent part by reference herein. The thermosettable dispersion can comprise microparticles comprising (a) an acid functional reaction product of ethylenically unsaturated monomers, and (b) a hydrophobic polymer having a number average molecular weight of at least 500. In certain embodiments, the hydrophobic polymer has an acid value of less than 20. The total amount of the additional aqueous polymeric resins can be, for example, from 5% to 60% by weight on a basis of total resin solids of the primary coating composition, such as from 12% to 40%, although higher or lower amounts could also be used.

In addition to the self-emulsified polyester microgel, the primer coating composition can also comprise one or more crosslinking materials capable of reacting with the functional groups of the self-emulsified polyester microgel to form a cured film. Any suitable crosslinking material may be used. Suitable crosslinking materials include aminoplasts and polyisocyanates, and mixtures thereof. Useful aminoplast resins may be based on the addition products of formaldehyde with an amino- or amido-group carrying substance. In one embodiment, the crosslinker is a methylated, high-imino melamine derivative such as that which is sold under the trade name of CYMEL 325.

While the aldehyde employed may be formaldehyde, other similar condensation products can be made from other aldehydes, such as acetaldehyde, crotonaldehyde, acrolein, benzaldehyde, furfural, glyoxal, and the like.

Condensation products of other amines and amides can also be used, for example, aldehyde condensates of triazines, diazines, triazoles, guanadines, guanamines, and alkyl- and aryl-substituted derivatives of such compounds, including alkyl- and aryl-substituted ureas and alkyl- and aryl-substituted melamines. Examples of such compounds include N,N′-dimethyl urea, benzourea, dicyandiamide, formaguanamine, acetoguanamine, glycouril, ammeline, 3,5-diaminotriazole, triaminopyrimidine, 2-mercapto-4,6-diaminopyrimidine and carbamoyl triazines of the formula C₃N₃(NHCOXR)₃ where X is nitrogen, oxygen or carbon and R is a lower alkyl group having from one to twelve carbon atoms or mixtures of lower alkyl groups, such as methyl, ethyl, propyl, butyl, n-octyl, and 2-ethylhexyl. Such compounds and their preparation are described in detail in U.S. Pat. No. 5,084,541 (column 2, line 50 through column 7, line 63) incorporated by reference in pertinent part herein.

The aminoplast resins may contain methylol or similar alkylol groups, and at least a portion of these alkylol groups may be etherified by reaction with an alcohol. Any monohydric alcohol can be employed for this purpose, including methanol, ethanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol.

Any suitable polyisocyanate may be used as a crosslinking agent. The polyisocyanate can be prepared from a variety of isocyanate-containing materials and can be a blocked polyisocyanate. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanates can be used. Examples of suitable blocking agents include those materials that would unblock at elevated temperatures such as lower aliphatic alcohols including methanol, oximes such as methyl ethyl ketoxime, lactams such as caprolactam and pyrazoles such as dimethylpyrazole.

The amount of the crosslinking material used can vary. In certain embodiments, it can range from 5% to 50% by weight on a basis of total resin solids of the primer coating composition, such as from 10% to 25%.

In certain embodiments, the primer coating composition may contain catalysts to accelerate the crosslinking reaction. Suitable catalysts for aminoplast cure may be selected from those known in the art and may include acids such as acid phosphates and sulfonic acid or a substituted sulfonic acid. Examples include dodecylbenzene sulfonic acid, paratoluene sulfonic acid, and the like. Suitable catalysts for isocyanate cure include organotin compounds such as dibutyltin oxide, dioctyltin oxide, dibutyltin dilaurate and the like. The catalyst may be present in varying amounts. In certain embodiments, the catalyst may be present in the amount of 0.05% to 5.0% by weight on a basis of total resin solids of the primer coating composition, such as from 0.08% to 2.0%.

In certain embodiments, additional ingredients such as pigments and fillers can be present in the primer coating composition. Any suitable pigments and fillers may be used. Useful pigments include hiding pigments such as titanium dioxide, zinc oxide, antimony oxide, etc. and organic or inorganic UV opacifying pigments such as iron oxide, transparent red or yellow iron oxide, carbon black, phthalocyanine blue, and the like. Useful fillers include barium sulfate, magnesium silicate, calcium carbonate, and silica. The amount of fillers and pigments can vary. In certain embodiments, the fillers and pigments may be present in the amount of 20% to 80% by weight on a basis of total solids of the primer coating composition, such as from 30% to 60%.

The primer coating composition can contain, in addition to the components described above, a variety of other optional materials. Such materials may include anti-oxidants, UV-absorbers and hindered amine light stabilizers such as hindered phenols, benzophenones, benzotriazoles, triazoles, triazines, benzoates, piperidinyl compounds and mixtures thereof. These materials may be added in any suitable amount. In certain embodiments, these materials may be added in amounts of 4% or less by weight on a basis of total solids of the primer coating composition. Other optional materials may include co-solvents, coalescing agents, neutralizing amines, defoamers, plasticizers, associative thickeners, bactericides and the like.

In certain embodiments, the primer composition exhibits some level of UV durability, which can be achieved through any means known in the art, such as the use of appropriate additives, the use of UV-durable film formers, and/or selection of monomers for use in the polyester microgel that are known to impart UV durability, such as aliphatic, rather than aromatic, monomers. In some embodiments, the polyester microgel comprises greater than 40 wt %, such as greater than 60 wt %, aliphatic monomers.

The primer coating composition comprising the self-emulsified polyester microgel may be applied onto the surface of the substrate, by any suitable coating process known to those skilled in the art. For example, the primer coating composition may be applied by dip coating, direct roll coating, reverse roll coating, curtain coating, spray coating, brush coating, electrostatic spray coating, and combinations thereof. The method and apparatus for applying the coating composition to the substrate is determined in part by the configuration and type of substrate material.

After application of the primer coating composition to the substrate, the composition can be at least partially dried by evaporating water and solvent (if present) from the surface of the film by air drying at ambient temperature (25° C.) or an elevated temperature for a period of time sufficient to dry the film but not significantly crosslink the components of the composition.

After the primer coating composition has been applied to the substrate and optionally dried (but not cured), a second coating composition is applied to at least a portion of the substrate coated with the primer coating composition. In certain embodiments, the second coating composition is a basecoat. The second coating composition may be a conventional basecoat coating composition as described, for example, in U.S. Pat. Nos. 7,709,093 (column 19, lines 56-60 and column 20, lines 22-43) and 6,180,181 (column 16, lines 18-33), both of which are incorporated in pertinent part by reference herein. Other suitable compositions may include those formulations commercially available from PPG Industries, Inc. as HWB and DWB. The second coating composition can include crosslinking materials, pigments, and additional ingredients such as those described above for the primer coating composition, or further described in U.S. Pat. No. 7,776,959 (column 4, line 38 through column 5, line 59) incorporated in pertinent part herein. In certain embodiments, the basecoat may be transparent or semi-transparent and/or may contain colorants such as effect pigments. As used herein, the phrase “transparent or semi-transparent” refers to coating layers and/or colorants used therein, such as pigments, with a haze of at least 5%. In certain embodiments of the present invention, the transparent or semi-transparent coatings/pigment has a haze of 5 up to 55%, or, in other embodiments, 10 up to 55%. Haze is a measurement of the transparency of a material and is defined by ASTM D1003. In such embodiments, some level of UV durability may be desired in the primer layer.

After application of the second coating, it can be at least partially dried by evaporating water and solvent (if present) from the surface of the film by air drying at ambient temperature (25° C.) or an elevated temperature for a period of time sufficient to dry the film but not significantly crosslink the components of the composition.

In an embodiment of the method of the present invention, after the second coating composition has been applied to the substrate coated with the primer coating composition and optionally dried (but not cured), a third coating composition may be applied to at least a portion of the substrate coated with the second coating composition. In certain embodiments, the third coating composition is a clearcoat. Examples of suitable clearcoat compositions include those described in U.S. Pat. Nos. 5,098,947 (column 3, line 9 through column 8, line 59), 5,196,485 (column 2, line 13 through column 10, line 47), 5,814,410 (column 4, line 51 through column 9, line 57), and 5,663,240 (column 2, line 10 through column 5, line 7), all of which are incorporated in pertinent part by reference herein. The third coating composition can include crosslinking materials, abrasion resistant particles such as those described in U.S. Pat. No. 7,053,149 (column 19, line 50 through column 24, line 29), incorporated in pertinent part herein, and additional ingredients such as those described above for the primer coating composition but typically not colorants that would render the coating opaque.

In those embodiments where a third coating composition has been applied to the substrate on at least a portion of the second coating composition, the substrate coated with the primer and subsequent coating compositions is heated to cure the coating compositions. In the curing operation, water and/or solvents are evaporated from the surface of the coating and the crosslinking reaction takes place. In certain embodiments, the heating or curing operation may be carried out at a temperature in the range of 71° C. to 177° C. for 20 to 40 minutes. Lower or higher temperatures can be used as necessary to activate crosslinking mechanisms. The thickness of the dried and crosslinked coating system can vary. In certain embodiments, the thickness of the dried and crosslinked coating system may be from 0.2 to 5 mils (5 to 125 micrometers), or from 0.4 to 10 mils (10 to 250 micrometers)

In other embodiments, the second coating composition is a monocoat. The monocoat coating composition may be a conventional coating composition such as that described above for the basecoat, but one in which a subsequent clear coat is not typically used. After application of the second coating, the substrate coated with the primer and second coating compositions is heated to cure the coating compositions. The curing operation may take place as described above for the case where the second coating is a basecoat. The thickness of the dried and crosslinked coating system can vary. In certain embodiments, the thickness of the dried and crosslinked coating system may be from 0.2 to 5 mils (5 to 125 micrometers), or from 0.4 to 10 mils (10 to 250 micrometers).

Use of the self-emulsified polyester microgel according to the method of the present invention may provide coating systems which, when cured, have one or more desirable properties such as good appearance (smoothness) and/or color control, good adhesion to the substrate, and/or chip resistance.

Accordingly, the present invention is also directed to a multilayer coating system comprising the primer layer, the second coating and the optional third coating as described herein.

Any substrate can be coated according to the method of the present invention. Suitable substrates can be formed from inorganic or metallic materials, thermoset materials, thermoplastic materials, and combinations thereof. The metal substrates coated by the methods of the present invention can include ferrous metals such as iron, steel, and alloys thereof, non-ferrous metals such as aluminum, zinc, and alloys thereof, and combinations thereof.

Before depositing the coatings upon the surface of the metal substrate according to the present invention, it may be desired to remove foreign matter from the metal surface by thoroughly cleaning and degreasing the surface by physical or chemical means such as are well know to those skilled in the art. A pretreatment coating, such a BONAZINC zinc-rich pretreatment (commercially available from PPG Industries, Inc.), can be deposited upon at least a portion of the surface of the metal substrate.

An electrodeposited coating is typically applied to the surface of an electroconductive substrate such as a metal substrate prior to applying the primer coating composition described above. Useful electrodepositable coating compositions include conventional anionic or cationic electrodepositable coating compositions. Methods for electrodepositing coatings are well known to those skilled in the art. Useful compositions and methods are discussed, for example, in U.S. Pat. No. 5,530,043 (relating to anionic electrodeposition) and U.S. Pat. Nos. 5,760,107; 5,820,987 and 4,933,056 (relating to cationic electrodeposition) incorporated by reference in pertinent part herein.

Useful thermoset materials include polyesters, epoxides, phenolics, polyurethanes and mixtures thereof. Useful thermoplastic materials include polyolefins, polyamides, thermoplastic polyurethanes, thermoplastic polyesters, acrylic polymers, vinyl polymers, copolymers and mixtures thereof.

Substrates coated according to the present invention can be, for example, automobile parts. The thickness of the substrate can vary as desired. Many load-bearing components of automobile bodies are formed from metal substrates, and these may include body panels, doors, fenders, hoods, or bumpers. Automobile parts typically formed from thermoplastic and thermoset materials include bumpers and trim. It is desirable to have a coating system which can be applied to both metal and non-metal parts.

As used herein, unless otherwise expressly specified, all numbers such as those expressing values, ranges, amounts or percentages may be read as if prefaced by the word “about”, even if the term does not expressly appear. Plural encompasses singular and vice versa. For example, while the invention has been described in terms of “a” self-emulsified polyester microgel, “a” polyester-melamine microgel, “a” polyester-acrylic microgel, and the like, mixtures of these and other components, including mixtures of microparticles, can be used. Also, as used herein, the term “polymer” is meant to refer to prepolymers, oligomers and both homopolymers and copolymers; the prefix “poly” refers to two or more. When ranges are given, any endpoints of those ranges and/or numbers of subranges within those ranges can be combined in any combination within the scope of the present invention. “Including”, “such as”, “for example” and like terms means “including/such as/for example but not limited to”.

### EXAMPLES

The present invention will be further described by reference to the following examples that are merely illustrative of the invention and are not intended to limit the invention to the specifics of the examples. Unless otherwise indicated, all parts are by weight.

### Example A

A polyester was prepared from the following ingredients:

| | Raw Material | Amount (g) |
|---|---|---|
| Chg 1 | Isomerginic acid SF¹ | 658 |
| | Trimethylolpropane | 333.4 |
| | 1,6-Hexanediol | 153 |
| | Phthalic anhydride | 278.4 |
| Chg 2 | Trimellitic anhydride | 182.6 |
| Chg 3 | Methylisobutylketone | 394 |

¹Isomerginic acid SF is available from Harburger Fettchemie and is mixture of fatty acids containing approx 60% of conjugated diene substituted C₁₈ fatty acid.

To a four necked, 2 liter reaction flask outfitted with a stirrer, gas inlet, thermometer and condenser was added the contents of Chg 1. The reaction mixture was heated in stages to 230° C. and held until the acid value was below 5. A slow nitrogen stream helped removed the water condensate. As soon as an acid number <5 was reached, the reaction was cooled to <150° C. Chg 2 was then added and the reaction mixture was heated to 190° C., and the acid value was measured every 30 minutes. Upon reaching an acid value of 32, the reaction mixture was cooled to 110° C. and then thinned with Chg 3. The resulting resin had a solids content of 80%.

### Example B

A polyester-melamine microgel in accordance with the invention was prepared from the following ingredients:

| | Raw Material | Amount (g) |
|---|---|---|
| Chg 1 | Polyester from Example A | 219.8 |
| Chg 2 | CYMEL 327² | 83.6 |
| Chg 3 | Dimethylethanolmine (DMEA) | 5.6 |
| | Deionized (DI) Water | 106 |
| Chg 4 | DI Water | 355 |
| Chg 5 | DMEA | 1.82 |
| | DI Water | 122 |
| Chg 6 | DI Water | 57 |

²CYMEL 327 is a methylated, high imino melamine derivative available from Cytec Industries, Inc.

To a 1 liter jacketed reaction vessel outfitted with a stirrer, gas inlet, thermometer and condenser was added the contents of Chg 1. Chg 2 was added under agitation to ensure homogeneity. The amount of DMEA in Chg 3 was calculated at 80% total neutralization based upon the acid value of the starting polyester. Chg 3 was then added and stirred for 5 minutes followed by the addition of Chg 4. The reaction mixture was heated to 88° C. Upon reaching 88° C., a sample was removed and the viscosity measured with a rotational viscometer. The measured viscosity increased as the reaction proceeded.

When a viscosity of 4000 mPas was reached, the temperature was reduced to 55° C. and the methylisobutylketone was removed under vacuum. Chg 5 & 6 were then added to fully neutralize the resin and reduce the solids to 25%.

### Example C

A polyester dispersion was prepared from the following ingredients:

| | Raw Material | Amount (g) |
|---|---|---|
| Chg 1 | EPON 880³ | 188 |
| | Isononanoic Acid | 158 |
| | Ethyltriphenylphosphonium iodide | 0.35 |
| Chg 2 | MACOL 98 BPA: EO⁴ | 492 |
| | 1,4-Cyclohexanedimethanol | 360 |
| Chg 3 | Maleic anhydride | 49 |
| | Trimellitic anhydride | 288 |
| Chg 4 | DOWANOL DPM⁵ | 165 |
| Chg 5 | Dimethylethanolamine | 52.2 |
| | Deionized (DI) Water | 470 |
| Chg 6 | DI Water | 2329 |

³EPON 880 is a Bisphenol A - epichlorohydrin resin available from Hexion Specialty Chemicals.
⁴Cymel MACOL 98 BPA: EO is an ethoxylated Bisphenol A polyol available from BASF.
⁵DOWANOL DPM is dipropylene glycol monomethyl ether, available from Dow Chemical Co.

To a four necked, 5 liter reaction flask outfitted with a stirrer, gas inlet, thermometer and condenser was added the contents of Chg 1. The reaction mixture was heated to 150° C. and held until the residual acid value was <3. The contents of Chg 2 and Chg 3 were then added to the flask and the reaction mixture was heated to 190° C. max ensuring that the column head temperature did not exceed 100° C. A slow nitrogen stream helped remove the water condensate. As soon as an acid number of 33 was reached, the reaction was cooled to 135° C. at which point Chg 4 was added with continued cooling to <100° C. When the reaction mixture was cooled to <100° C. an aqueous dispersion was produced by adding Chg 5 and Chg 6. The final dispersion had a solids content of 32% and a pH value of 6.5.

### Example D

A polyester-acrylic microgel in accordance with the invention was prepared from the following ingredients:

| | Raw Material | Amount (g) |
|---|---|---|
| Chg 1 | Polyester from Example C | 1500 |
| | Dimethylethanolamine (DMEA) | 2.3 |
| | Deionized (DI) Water | 240 |
| Chg 2 | Hydroxyproyplmethacrylate | 33.2 |
| | Styrene | 66.4 |
| | Butyl Acrylate | 66.4 |
| Chg 3 | Isoascorbic acid | 0.511 |
| | DI Water | 5 |
| Chg 4 | Ferrous Ammonium Sulfate | 0.0034 |
| | DI Water | 5 |
| Chg 5 | Hydrogen Peroxide (35%) | 2.34 |
| | DI Water | 20 |
| Chg 6 | DMEA | 4.58 |
| | DI Water | 5 |

To a four necked, 5 liter reaction flask outfitted with a stirrer, gas inlet, thermometer, and condenser was added the contents of Chg 1. While the reaction was heating to 35° C. vacuum was applied to remove the dissolved oxygen. Upon reaching 35° C., the vacuum was broken with a nitrogen stream and the reaction was continued under nitrogen atmosphere. Chg 2 was added followed by stirring for 5 minutes, then Chg 3 & 4 were added followed by stirring for 5 minutes. Chg 5 was then added all at once and within 2 minutes an exotherm ensued. The reaction temperature reached 55° C. within 10 minutes. The reaction was then heated to 65° C. and held for 1 hour to ensure complete monomer conversion. The reaction was then cooled to 35° C. and Chg 6 was added. A nearly transparent dispersion with a solids content of 35% and pH of 6.8 was obtained.

### Example 1

### Primer Coating Composition Using Polyester-Melamine Microgel

A primer coating composition in accordance with the invention was prepared from the following ingredients. Pigment dispersions available commercially from PPG Industries Inc. were first blended in a suitable vessel for waterborne material.

| Material | Amount (g) |
|---|---|
| 86T62-9166 TiO2 tinting paste | 175.43 |
| available from PPG Ind. Inc. | |
| 86B2792 Carbon Black | 43.85 |
| Tinting Paste available from PPG | |
| Ind. Inc | |

These ingredients were mixed for 15 minutes, and the following ingredients were added with agitation:

| Material | Amount (g) |
|---|---|
| CYMEL 325⁶ | 21.25 |
| Propylene glycol | 5.00 |
| Ethylene glycol monohexyl ether | 3.30 |
| ISOPAR K MINERAL SPIRIT⁷ | 3.80 |
| Diethylene glycol monobutyl ether | 4.90 |

⁶CYMEL 325 is a methylated, high imino melamine derivative, available from Cytec Industries, Inc.
⁷ISOPAR K MINERAL SPIRIT, available from ExxonMobil Chemical Company.

This mixture was agitated for 15 minutes and the following resinous binders were added:

| Material | Amount (g) |
|---|---|
| Polyester-melamine Microgel of | 157.92 |
| Example B | |
| Polyurethane dispersion (prepared as | 51.68 |
| described in U.S. Pat. No. 7,709,092, Example 1) | |
| Deionized water | 12.67 |
| Dimethyl ethanol amine (50% solution | 1.33 |
| in deionized water) | |

The viscosity of the sample was 21 seconds #4 Ford with a pigment to binder ratio of 1.09/1 and solids of 43.42%. The pH of the sample was 8.57.

### Example 2

### Primer Coating Composition Using Polyester Acrylate Resin

A primer coating composition similar to Example 1 was prepared from the following ingredients. Pigment dispersions were first blended in a suitable vessel for waterborne material.

| Material | Amount (g) |
|---|---|
| 86T62-9166 TiO₂ tinting paste | 175.43 |
| available from PPG Ind. Inc. | |
| 86B2792 Carbon Black | 43.85 |
| Tinting Paste available from PPG | |
| Ind. Inc | |

These ingredients were mixed for 15 minutes, and the following ingredients were added with agitation:

| Material | Amount (g) |
|---|---|
| CYMEL 325 | 21.25 |
| Propylene glycol | 5.00 |
| Ethylene glycol monohexyl ether | 3.30 |
| ISOPAR K MINERAL SPIRIT | 3.80 |
| Diethylene glycol monobutyl ether | 4.90 |

This mixture was agitated for 15 minutes and the following resinous binders were added:

| Material | Amount (g) |
|---|---|
| Polyester-acrylic Microgel of | 112.80 |
| Example D | |
| Polyurethane dispersion (prepared | 51.68 |
| as described in U.S. Pat. No. 7,709,092, | |
| Example 1) | |
| Deionized water | 30.33 |
| Dimethyl ethanol amine (50% | 2.00 |
| solution in deionized water) | |

The viscosity of the sample was 25 seconds #4 Ford with a pigment to binder ratio of 1.09/1 and solids of 45.98%. The pH of the sample was 8.56.

### Example 3

### Primer Coating Composition Using Polyester Acrylic Microgel as a Pigment Grind Vehicle

A primer coating composition in accordance with the invention was prepared from the following ingredients. A pigment paste was first made with the following ingredients:

| Material | Amount (g) |
|---|---|
| Polyester-acrylic Microgel of | 67.20 |
| Example D | |
| Deionized water | 7.96 |
| Dimethyl ethanol amine (50% | 0.47 |
| solution in deionized water) | |
| DREWPLUS L 108 Defoamer⁸ | 2.27 |
| BYK - 181 Grinding additive⁹ | 4.15 |
| RAVEN 410 Carbon Black¹⁰ | 3.36 |
| R972 Fumed Silica¹¹ | 1.12 |
| Barium sulfate available from | 95.20 |
| Solvay | |
| Titanium Dioxide¹² | 5.60 |
| Magnesium silicate Microtalc MP 10-52¹³ | 6.72 |
| Deionized water | 4.92 |

⁸Available from Ashland Chemicals.
⁹Available from Byk-Chemie.
¹⁰Available from Columbian Chemicals.
¹¹Available from Degussa.
¹²Available from DuPont Chemicals.
¹³Available from Baretts Minerals.

These ingredients were first dispersed with a high speed cowls dissolver for one hour. This premix was then milled for 1.5 hours using an Eiger Media mill. To this paste, the following ingredients were added with agitation:

| Material | Amount (g) |
|---|---|
| CYMEL 325 | 21.25 |
| Propylene glycol | 5.00 |
| Ethylene glycol monohexyl ether | 3.30 |
| Isopar K Mineral Spirit | 3.80 |
| Diethylene glycol monobutyl ether | 4.90 |

This mixture was agitated for 15 minutes and the following resinous binders were added:

| Material | Amount (g) |
|---|---|
| Thermosettable dispersion | 87.35 |
| (prepared as described in U.S. Pat. No. | |
| 6,180,181) | |
| Polyurethane dispersion (prepared | 51.68 |
| as described in U.S. Pat. No. 7,709,092, | |
| Example 1) | |
| Deionized water | 30.27 |
| Dimethyl ethanol amine (50% | 3.01 |
| solution in deionized water) | |

The viscosity of the sample was 27 seconds #4 Ford with a pigment to binder ratio of 1.12/1 and solids of 52.94%. The pH of the sample was 8.60.

The primer coating compositions of these examples were tested in a wet-on-wet-on-wet (WOWOW) system versus a water based control. The water based control primer was JWPW8110, which is commercially available from PPG Kansai Automotive Finishes. The test substrates were ACT cold rolled steel panels, 10.16 cm by 30.48 cm (4 inch by 12 inch), electrocoated with a cationically electrodepositable coating commercially available from PPG Industries, Inc., as ED6060. The primer coating composition of each example and the water based control were spray applied (1 coat automated spray at 0.8 mils) to the panels at 60% relative humidity and 21° C. One set of panels was kept at ambient temperature (25° C.) for 5 minutes prior to applying the basecoats (“Ambient Flash” in Table 1). A second set of panels was partially dehydrated by flashing at 80° C. for 5 minutes prior to application of the basecoats (“Heated Flash” in Table 1).

All of the panels were then coated (2 coats automated spray at 0.55 mils) with a light blue metallic basecoat known as JWBW8R3 (commercially available from PPG Kansai Automotive Finishes). The panels were flash baked for 5 minutes at 80° C. and then coated (2 coats automated spray at 1.9 mils) with a clearcoat, Kino JCC1200 (commercially available from PPG Kansai Automotive Finishes). The panels were baked for 10 minutes at 110° C. and then for 20 minutes at 140° C.

The solvent based control panel was coated with a primer coating, FCP6519, available from PPG Kansai Automotive Finishes and then baked for 30 minutes at 140° C. to completely cure the coating. The base coat and clear coat were then applied as described above for the water based control and the example compositions.

The smoothness of the clearcoats was measured using a Byk Wavescan in which results are reported as long wave and short wave numbers where lower values means smoother films. The following Table 1 provides the measured properties.

TABLE 1

| | Can | Spray | Flash | Long | Short |
|---|---|---|---|---|---|
| Example | Solids¹⁴, % | Solids¹⁵, % | Type | wave | wave |
| SB Control | 60.0 | 65.7 | Fully cured | 4 | 26 |
| WB Control | 44.8 | 47.1 | Ambient¹⁶ | 6 | 34 |
| | | | heated¹⁷ | 5 | 30 |
| Example 1 | 43.4 | 50.5 | ambient | 5 | 28 |
| | | | heated | 5 | 28 |
| Example 2 | 46.0 | 51.1 | ambient | 5 | 29 |
| | | | heated | 5 | 27 |
| Example 3 | 52.9 | 59.2 | ambient | 5 | 28 |
| | | | heated | 5 | 29 |

¹⁴Can solids are measured on the liquid coating formula. The preweighed sample is heated in a foil pan at 110° C. for 60 min and the % nonvolatile material is calculated.
¹⁵Spray solids are measured on a coating sample that has been spray applied to a 4″ × 4″ foil square and flashed at ambient temperature (25° C.) for 5 minutes. The coated substrates are heated at 140° C. for 30 minutes and the % nonvolatile material is calculated.
¹⁶Ambient flash panels were kept at ambient temperature (25° C.) for 5 minutes prior to applying the basecoats.
¹⁷Heated flash panels were heated at 80° C for 5 minutes prior to application of the basecoats.

As shown in Table 1, each of the examples 1-3 have smoothness comparable to the solvent based control and better than the water based control, with either an ambient or a heated flash. The solids of examples 1-3 are all higher than the water based control, with that of Example 3 comparable to the solvent based control.

Whereas particular embodiments of this invention have been described above for purposes of illustration, it will be evident to those skilled in the art that numerous variations of the details of the present invention may be made without departing from the invention as defined in the appended claims.

We claim:

1. A method for coating a substrate, comprising:
a. applying a primer coating composition onto at least a portion of a substrate, wherein the primer coating composition comprises a self-emulsified polyester microgel;
b. applying a second coating composition to at least a portion of the substrate coated with the primer coating composition of component (a) without first substantially curing the primer coating composition of component (a);
c. optionally, applying a third coating composition to at least a portion of the substrate coated with the coating composition of component (b) without first substantially curing (a) and/or (b);
d. substantially curing the coating compositions of components (a), (b) and, if used, (c).

2. The method of claim 1, wherein one or more of the coating compositions of (a), (b) and (c), if used, is waterborne.

3. The method of claim 1, wherein the self-emulsified polyester microgel comprises a polyester-melamine microgel.

4. The method of claim 3, wherein the polyester of the polyester-melamine microgel comprises a reaction product comprising isomerginic acid, trimethylol propane, 1,6-hexanediol, phthalic anhydride, and/or trimellitic anhydride.

5. The method of claim 3, wherein the polyester comprises acid functionality.

6. The method of claim 3, wherein the melamine of the polyester-melamine microgel comprises a methylated, high-imino melamine derivative.

7. The method of claim 1, wherein the self-emulsified polyester microgel comprises a polyester-acrylic microgel.

8. The method of claim 7, wherein the polyester-acrylic microgel is prepared by a method comprising:
a. reacting an anhydride and/or polyacid comprising a polymerizable double bond, a polyacid, and a polyol, to form a polyester comprising carboxylic acid groups;
b. neutralizing at least a portion of the carboxylic acid groups of the polyester;
c. dispersing the neutralized polyester into aqueous solution;
d. adding an ethylenically unsaturated monomer to the polyester dispersion;
e. polymerizing the ethylenically unsaturated monomer.

9. The method of claim 8, wherein the anhydride comprising a polymerizable double bond comprises maleic anhydride.

10. The method of claim 7, wherein the polyester of the polyester-acrylic microgel comprises a reaction product comprising epoxy resin, ethoxylated epoxy resin, isononanoic acid, trimellitic anhydride, and/or maleic anhydride.

11. The method of claim 7, wherein the acrylic of the polyester-acrylic microgel comprises styrene, n-butyl acrylate, and/or 2-hydroxypropyl methacrylate.

12. The method of claim 1, wherein the coating composition of component (a) further comprises a thermosettable dispersion.

13. The method of claim 12, wherein the thermosettable dispersion further comprises an additional microgel that is different from the self-emulsified polyester microgel of (a).

14. The method of claim 13, wherein the additional microgel comprises polymeric microparticles comprising a reaction product comprising:
i. at least one acid functional reaction product of ethylenically unsaturated monomers; and
ii. at least one hydrophobic polymer having a number average molecular weight of at least 500.

15. A multilayer coating system comprising
a. a primer coating composition applied to at least a portion of a substrate, wherein the primer coating composition comprises a self-emulsified polyester microgel;
b. a second coating composition applied to at least a portion of the substrate coated with the primer coating composition of component (a) without first substantially curing the primer coating composition of component (a);
c. optionally, a third coating composition applied to at least a portion of the substrate coated with the coating composition of component (b) without first substantially curing (a) and/or (b);
d. substantially curing the coating compositions of components (a), (b) and, if used, (c).

16. The method of claim 1, wherein the primer coating composition comprises a pigment grind vehicle that comprises the self-emulsified polyester microgel.

17. The multilayer coating system of claim 15, wherein the self-emulsified polyester-acrylic microgel comprises 40 wt % or greater aliphatic monomers.

18. The multilayer coating system of claim 17, wherein the second coating is transparent or semi-transparent.
